(19) United States
(12) Patent Application Publication
(10) Pub. No.: US 2022/0393589 A1
(43) Pub. Date: Dec. 8, 2022

(54) VOLTAGE CONVERTER WITH FEEDBACK USING VARIABLE PROPORTIONAL GAIN

(71) Applicants: AES Global Holdings PTE Ltd., Singapore (SG); The Regents of the University of Colorado, Denver, CO (US)

(72) Inventors: Dragan Maksimovic, Boulder, CO (US); Faleh Alskran, Timnath, CO (US); V. Inder Kumar, Boulder, CO (US); Chandan Suthar, Boulder, CO (US)

(21) Appl. No.: 17/805,291

(22) Filed: Jun. 3, 2022

Related U.S. Application Data
(60) Provisional application No. 63/196,918, filed on Jun. 4, 2021.

(51) Int. Cl. H02M 3/157; H02M 1/00; H02M 1/08

(52) U.S. Cl. CPC H02M 3/157; H02M 1/0025; H02M 1/08

(57) ABSTRACT

A voltage converter comprises a drive control circuit configured to generate switch control signals and a feedback circuit. The feedback circuit comprises a proportional control and a gain controller. The feedback circuit is configured to receive a sensed output voltage based on an output DC voltage, receive a voltage reference, obtain an input voltage value based on an input DC voltage, and generate an error signal based on a comparison of the sensed output voltage with the voltage reference. The feedback circuit is further configured to obtain a proportional gain value based on the voltage reference and the input voltage value and to generate a proportional value based on the proportional gain value and the error signal.

### CROSS-REFERENCE TO RELATED APPLICATIONS

This application claims the benefit to and priority of U.S. Provisional Application No. 63/196,918, filed Jun. 4, 2021. The entire disclosure of the above application is incorporated herein by reference.

### TECHNICAL FIELD

Aspects of the disclosure relate to DC-DC converters and more particularly to multilevel converters that have high efficiency and power density.

### BACKGROUND

A power supply typically converts an incoming input voltage into a different, output voltage. For example, an alternating current (AC) input voltage may be converted to a direct current (DC) voltage for use by electronic equipment. In another example, a first DC input voltage may be converted to a different DC voltage for use by electronic equipment.

Power supply topologies can include stepping down voltage in the form of a buck converter. The buck converter may be used to provide a well-regulated output voltage or current from a poorly regulated input power source. The buck converter can find a use in many different power-electronics applications due to its simple and robust nature.

A known building block 100 in a multilevel arrangement is illustrated in FIG. 1. Buck converter 100 includes four series-connected switches S₁, S̅₁̅, S₂, S̅₂̅ coupled to an inductor L_{f} of an LC filter that also includes capacitor C_{f}. A converted output voltage across the capacitor C_{f} is coupleable to a load. The arrangement of the switches S₁, S̅₁̅, S₂, S̅₂̅ also includes a flying capacitor C₁ to form a flying-capacitor multilevel (FCML) assembly 102, which generally enables a higher effective switching frequency, reduces voltage stresses, and increases efficiency.

Through appropriate control of the FCML assembly 102, the input voltage vᵢₙ can be converted to a target output voltage within a range of output voltage values. For example, in the case of a buck converter, the input voltage can be stepped down to lower output voltages. Further, the output voltage may be commanded to change from a first value to another value higher or lower than the first value. The transition time that the converter takes to change between outputting the first voltage value and outputting the new voltage value can fall outside desirable transient specifications, e.g., settling time, voltage overshoot or undershoot, in applications where high bandwidth and high efficiency are desired.

### OVERVIEW

In accordance with one aspect of the present disclosure, a voltage converter comprises a voltage input adapted to receive an input DC voltage, a DC-to-DC converter comprising a plurality of controllable switch devices and configured to convert the input DC voltage into an output DC voltage, and a voltage output adapted to receive the output DC voltage. The voltage converter also comprises a drive control circuit configured to generate switch control signals and a feedback circuit coupled to the DC-to-DC converter. The feedback circuit comprises a proportional control and a gain controller. The feedback circuit is configured to receive a sensed output voltage based on the output DC voltage, receive a voltage reference, obtain an input voltage value based on the input DC voltage, and generate an error signal based on a comparison of the sensed output voltage with the voltage reference. The feedback circuit is further configured to obtain a proportional gain value based on the voltage reference and the input voltage value and to generate a proportional value based on the proportional gain value and the error signal. The drive control circuit is further configured to generate the switch control signals based on the generated proportional value.

In accordance with another aspect of the present disclosure, a method for controlling a DC-DC converter is provided. The DC-DC converter comprises a DC-to-DC converter, a drive control circuit, and a feedback circuit. The method comprises providing, to the feedback circuit, an input voltage value, and a voltage reference. The method also comprises generating an error signal based on the sensed output voltage and the voltage reference, obtaining a proportional gain value based on the voltage reference and the input voltage value, generating a proportional value based on the error signal and the proportional gain value, and driving the DC-to-DC converter to generate an output voltage based on the proportional value.

In accordance with another aspect of the present disclosure, a method for generating a proportional gain value lookup table for a DC-DC converter circuit is provided. The DC-DC converter circuit comprises a DC-to-DC converter, a drive control circuit, and a feedback circuit comprising a proportional control. The method comprises setting a proportional gain value of the proportional control to a first proportional gain value and executing an iteration sequence. The iteration sequence comprises setting a first circuit parameter for the DC-DC converter circuit, setting a second circuit parameter for the DC-DC converter circuit, and setting a third circuit parameter for the DC-DC converter circuit. The iteration sequence also comprises controlling the DC-DC converter circuit based on ones of the first, second, and third circuit parameters related to an input voltage and a beginning reference voltage and based on the proportional gain value. The iteration sequence further comprises applying a new reference voltage to the DC-DC converter circuit, wherein the new reference voltage is based on one of the first, second, and third circuit parameters related to a delta reference voltage change. The iteration sequence also comprises controlling the DC-DC converter circuit based on application of the new reference voltage and based on the proportional gain value and comprises monitoring an output voltage of the DC-DC converter circuit to determine a settling time of the output voltage in reaching a value substantially equal to a value of the new reference voltage. The proportional gain value is stored if the settling time is below a target threshold.

### BRIEF DESCRIPTION OF THE DRAWINGS

The drawings illustrate embodiments presently contemplated for carrying out the invention.

In the drawings:

FIG. 1 is a circuit diagram of a known multilevel DC-DC step-down converter.

FIG. 2 is a circuit diagram of a multilevel DC-DC step-down converter according to an embodiment.

FIGS. 3-8 illustrate graphs of plotted optimal proportional gain values according to an embodiment.

FIG. 9 is a circuit diagram of a multilevel DC-DC step-down converter according to another embodiment.

FIG. 10 is a circuit diagram of a multilevel DC-DC step-down converter according to another embodiment.

FIG. 11 is a circuit diagram of a modulator according to an embodiment.

FIG. 12 is a flowchart illustrating a lookup table generation procedure according to an embodiment.

FIG. 13 is a flowchart illustrating an optimal proportional gain value calculation procedure according to an embodiment.

FIG. 14 is a flowchart illustrating a proportional gain value modification procedure according to an embodiment.

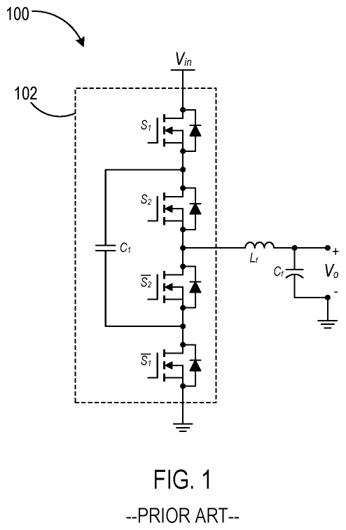

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

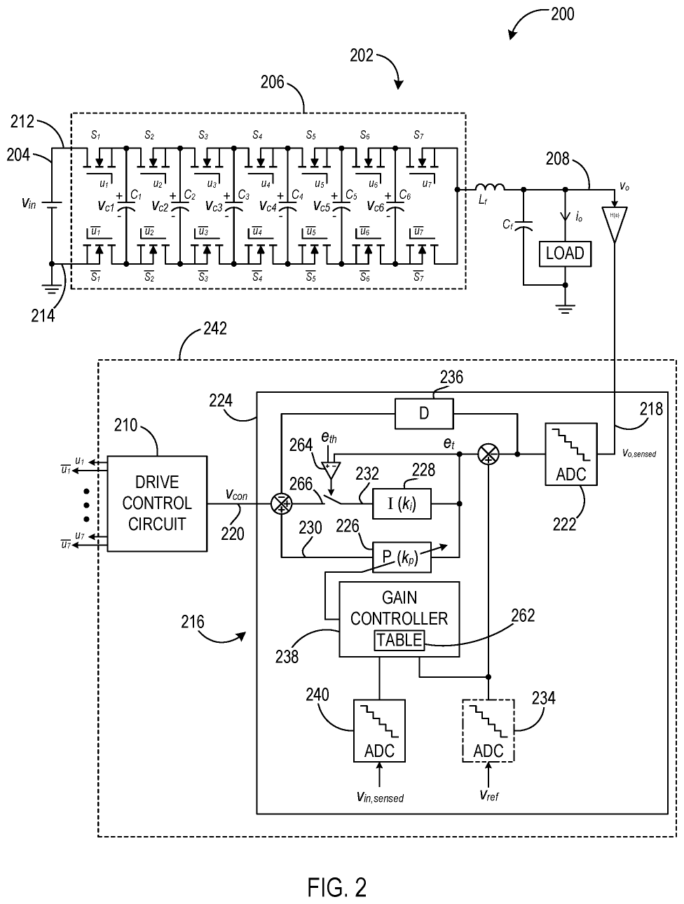

FIG. 2 is a circuit diagram of a multilevel DC-DC step-down converter 200 according to an embodiment. Multilevel converter 200 includes a buck converter circuit 202 having a voltage input 204, an FCML assembly 206, a series choke or inductor L_{f}, an output capacitor C_{f}, a voltage output 208, and a drive control circuit (e.g., controller) 210. the buck converter 202 is a DC-to-DC voltage converter configured to convert an input DC voltage vᵢₙ to a lower output DC voltage vₒ. The FCML assembly 206 includes a multi-stage assembly having a plurality of controllable switch device pairs (e.g., S₁S̅₁̅, S₂S̅₂̅, . . . , SₙS̅ₙ̅) in each stage and a plurality of flying capacitors (e.g., C₁-Cₙ) coupled between each stage. As illustrated, the FCML assembly 206 is an eight-level assembly having seven controllable switch pairs with six flying capacitors coupled between each pair. Embodiments of the disclosure are not limited to an eight-level FCML assembly as shown, however, but can be applied to an FCML assembly of two or more levels. The upper switches (e.g., S₁, S₂, . . . , S₇) of the controllable switch device pairs are serially coupled together between a positive terminal 212 of the voltage input 204 and the series inductor L_{f}, and the lower switches (e.g., S̅₁̅, S̅₂̅, . . . , S̅₇̅) of the controllable switch device pairs are serially coupled together between a negative terminal 214 of the voltage input 204 and the series inductor L_{f}. Respective flying capacitors C₁-C₆ are coupled between each series-connected pair of upper switches and the respective series-connected pair of lower switches. For example, the flying capacitor C₁ is coupled between series-connected upper switches S₁, S₂ and series-connected lower switches S̅₁̅, S̅₂̅.

The controller 210 is configured to generate control signals e.g., u₁, u̅₁̅, u₂, u̅₂̅, . . . , uₙ, u̅ₙ̅ that control the plurality of controllable switch devices S₁, S̅₁̅, S₂, S̅₂̅, . . . , S₇, S̅₇̅ to produce a desired output voltage at the voltage output 208. In one embodiment, the upper and lower switches of each controllable switch device pair (e.g., S₁, S̅₁̅) are controlled in a complementary manner such that when one switch (e.g., S₁) is controlled into its conducting state, the other switch (e.g., S̅₁̅) is controlled into its non-conducting state and vice versa.

Through pulse-width modulation (PWM) such as phase-shifted PWM control signals, the controller 210 uses periodic switching of the controllable switch devices S₁, S̅₁̅, S₂, S̅₂̅, . . . , S₇, S̅₇̅ to step down the input voltage vᵢₙ. By timing the switches of the multiple stages, pulsating waveforms are produced and filtered by L_{f} so that a conversion from vᵢₙ to vₒ is achieved. The duty cycle of the PWM signals operates to drive the output voltage vₒᵤₜ to its desired value. However, the output voltage can vary based on differences in load current, for example. Accordingly, providing feedback to the controller 210 based on the output voltage and/or duty cycle allows the controller 210 to compensate for the output voltage variability.

FIG. 2 illustrates a feedback circuit 216 configured to receive a sensed output voltage 218 from the buck converter 202 and to provide a feedback control voltage v_{con} 220 to the controller 210 for adjusting the output voltage vₒᵤₜ in response to the output voltage drifting away from a target or reference voltage. The sensed output voltage v_{o,sensed} may be converted to a digital signal by an analog-to-digital converter (ADC) 222 for use by a digital controller 224. Digital controller 224 implements a proportional-integral-derivative (PID) control scheme to generate the feedback control voltage 220 for use by the controller 210. The sensed output voltage v_{o,sensed} is compared with a reference voltage v_{ref} to generate an error value eₜ (v_{ref}−v_{o,sensed}), which is used by the proportional control 226 and the integral control 228 to generate proportional and integral signals or values 230, 232, respectively. The reference voltage v_{ref} may be generated by an analog device and may be digitized by a second ADC 234 if required, or the reference voltage v_{ref} may be in digital form for direct comparison with the digitized sensed output voltage v_{o,sensed}. The digital reference voltage v_{ref} may be obtained from a lookup table, for example, or may be generated in another process in the digital controller 224. In one embodiment, the proportional value 230 is calculated based on the error value and a proportional gain value kₚ as follows:

kₚ(v_{ref}−v_{o,sensed}) (Eqn. 1),

and the integral value 232 is calculated based on an integral of the error value and an integral gain value kᵢ as follows:

kᵢ∫(v_{ref}−v_{o,sensed})dt (Eqn. 2).

As illustrated in FIG. 2 according to one embodiment, the derivative control 236 uses the sensed output voltage v_{o,sensed} independent of the reference voltage v_{ref} as follows:

$${C}_{f} \frac{d {v}_{o , sensed}}{dt} . \qquad ( Eqn . 3 )$$

However, embodiments of this disclosure are not restricted to the equations above for the PID controls 226, 228, 236, and other equations may be used within the scope of this disclosure. For example, the derivative control 236 may be based on the error value and a differential gain value k_{d} such as:

$${k}_{d} \frac{d ( {v}_{r e f} - {v}_{o , sensed} )}{dt} . \qquad ( Eqn . 4 )$$

Equations 1-4 are exemplary equations useful in determining the feedback control voltage 220 by the digital controller 224, but embodiments of the disclosure are not so limited. The PID controls 226, 228, 236 may use alternative equations in determining the feedback control voltage 220 without deviating from the scope disclosed herein.

Through appropriate determination of the feedback control voltage 220, the output voltage vₒ can be driven toward the reference voltage v_{ref} if it is not equal to or substantially equal to the reference voltage v_{ref} or can be driven to maintain its current value if it is equal to or substantially equal to the reference voltage v_{ref}. As used herein, the output voltage vₒ is substantially equal to the reference voltage v_{ref} when a load, configured to receive an input load voltage equal to the reference voltage v_{ref}, cannot distinguish a difference between the output voltage vₒ and the input load voltage.

While the goal of the controller 210 and the feedback circuit 216 is to produce an output voltage vₒ equal to or substantially equal to the reference voltage v_{ref}, the time (i.e., settling time) it takes to achieve the goal such that the output voltage vₒ settles to or around the reference voltage v_{ref}, especially in response to a change in the voltage reference v_{ref}, is dependent on a plurality of factors. For example, factors of the components, such as L_{f}, C_{f}, of the multilevel converter 200 such as their values, tolerances, and temperatures can affect the settling time. Further, properties of conduction through switches, inductors, capacitors, comparators, and the like also affect the settling time. Because of such real-world factors, an ideal instantaneous settling time is unachievable. Instead, a fundamental limit exists where the fundamental limit represents the quickest time that a given real-world circuit can reach the settling time. Embodiments of the disclosure are directed to reducing settling times toward the fundamental limit.

The gain values kₚ and kᵢ of the PI controls 226, 228 (and k_{d} of the derivative control 236 if used) affect the settling time. Choosing appropriate values for these gain values can reduce the settling time toward the fundamental limit. It has been found that the value for the proportional gain value kₚ determined to be effective in reducing the settling time at one set of circuit parameters is not as effective in other sets of circuit parameters. For example, a first proportional gain value kₚ found to be effective in reducing the settling time in response to a first delta voltage change in the reference voltage v_{ref} at a given input voltage vᵢₙ is not as effective in reducing the settling time in response to the first delta voltage change in the reference voltage v_{ref} at a different input voltage vᵢₙ or in response to a second delta voltage change in the reference voltage v_{ref} at the same given input voltage vᵢₙ. Additionally, an effective proportional gain value kₚ during a first delta voltage change in a first reference voltage v_{ref} at a given input voltage vᵢₙ can be less effective during a same first delta voltage change in a second reference voltage v_{ref} at the same given input voltage vᵢₙ. Accordingly, setting the proportional gain value kₚ to a fixed value that has been determined to be an optimal value effective at reducing the settling time at one set of circuit parameters and leaving the fixed value unchanged during other circuit parameters can extend the settling time away from the fundamental limit and reduce optimization of the circuit performance.

To optimize the settling time of the multilevel converter 200 when changing from a first v_{ref} to a different v_{ref}, a gain controller 238 is configured to receive the reference voltage vᵣₑf and an input voltage value such as the sensed input voltage v_{in,sensed}, which may be converted to a digital signal by an ADC 240. In some embodiments, the input voltage is known in advance or of an expected value such that the gain controller 238 may use the predetermined input voltage value as a substitute in the calculations based on a sensed input voltage. In other embodiments, the gain controller 238 receives and relies on the sensed input voltage v_{in,sensed}, for its calculations as described below. The gain controller 238 keeps track of the reference voltage v_{ref} and determines a delta voltage change Δv_{ref} between the current reference voltage v_{ref} (e.g., v_{ref,old}) and a new reference voltage v_{ref,new} representing a different target output voltage vₒ desired at the voltage output. The new voltage reference v_{ref,new} received becomes the current reference voltage v_{ref,old} after one or more operations. In addition to calculating the delta voltage change Δv_{ref}, the gain controller 238 keeps track of the current reference voltage v_{ref,old} and uses it, along with the delta voltage change Δv_{ref} and the sensed input voltage v_{in,sensed}, to determine an optimal proportional gain value kₚ₁ such that the output voltage vₒ achieves a value equal to or substantially equal to the new voltage reference v_{ref,new} in an optimal minimized settling time. In one embodiment, the functions and components of the digital controller 224 and of the controller 210 may be integrated into a single controller 242.

FIGS. 3-5 illustrate graphs 244, 246, 248 of plotted optimal proportional gain values k_{p_opt}. In each graph 244, 246, 248, values for each of the parameters vᵢₙ, v_{ref}, and Δv_{ref} are used to generate proportional gain curves representative of respective optimal proportional gain values k_{p_opt} for various combinations of the parameters for a given circuit such as the multilevel converter 200 of FIG. 2. Referring to FIG. 3, a given input voltage vᵢₙ (e.g., vᵢₙ₂) is held constant while varying Δv_{ref} values at different v_{ref} values are used to calculate respective optimal proportional gain values k_{p_opt}. In graph 244, the horizontal axis represents increasing delta voltage changes Δv_{ref}, and the vertical axis represents the optimal proportional gain values k_{p_opt}. The curves v_{ref1}-v_{ref4} represent the current or old reference voltages v_{ref,old} from which the delta voltage changes Δv_{ref} begin. For example, the reference voltage curves v_{ref1}-v_{ref4} may represent starting reference voltages of 25V, 50V, 75V, 100V in one embodiment.

Based on the current reference voltage v_{ref,old}, an optimal proportional gain value k_{p_opt} that yields an optimal settling time for a delta voltage change Δv_{ref} from the current reference voltage v_{ref,old} to a new voltage reference v_{ref,new} may be determined. For example, a delta voltage change Δv_{ref1} from the current reference voltage v_{ref1} to the new voltage reference v_{ref,new} (e.g., v_{ref1}+Δv_{ref1}) at a point 250 on the v_{ref1} curve can be determined to be an optimal proportional gain value kₚ₁. Similarly, delta voltage changes Δv_{ref2}, Δv_{ref3} from respective current reference voltages v_{ref4}, v_{ref2} to their new respective voltage reference v_{ref,new} at points 252, 254 can be determined to be optimal proportional gain values kₚ₂, kₚ₃. In this manner, optimal proportional gain values k_{p_opt} for a plurality of current reference voltages v_{ref,old} at various delta voltage change values Δv_{ref} at a fixed input voltage vᵢₙ can be determined.

As stated above, the curves v_{ref1}-v_{ref4} represent the current or old reference voltages v_{ref,old} from which the delta voltage changes Δv_{ref} begin. For the given input voltage vᵢₙ, the maximum delta voltage change Δv_{ref} for each curve v_{ref1}-v_{ref4} depends in part on the beginning current reference voltage and a maximum voltage achievable by the multilevel converter 200. For example, if the current reference voltage v_{ref} of v_{ref4} begins at 100V and the current reference voltage v_{ref} of v_{ref1} begins at 25V as stated above, the maximum delta voltage change Δv_{ref} of current reference voltage v_{ref4} ends sooner than the maximum delta voltage change Δv_{ref} of current reference voltage v_{ref1} since subtracting 100V from the maximum voltage is less than subtracting 25V from the maximum voltage. Accordingly, the range of delta voltage changes Δv_{ref} for each curve v_{ref1}-v_{ref4} shortens as the starting current reference voltages v_{ref} increase.

In one embodiment, a lookup table of optimal proportional gain values k_{p_opt} for each current reference voltage v_{ref} at a given input voltage vᵢₙ (e.g., vᵢₙ₂) over a range of delta voltage change Δv_{ref} can be determined. In a first iteration, the multilevel converter 200 may be provided with the given input voltage vᵢₙ and the current reference voltage v_{ref} set to v_{ref1} and allowed to reach a steady-state operation such that the output voltage vₒ is substantially equal to the reference voltage v_{ref1}. Next, the output voltage vₒ may be monitored in response to the reference voltage v_{ref1} being changed to a new value. The reference voltage may be changed, for example, from a reference voltage v_{ref1} of 25V to a new reference voltage of 105V. Accordingly, a delta voltage change Δv_{ref} of 80V can result from the change to the new reference voltage. A first value for the proportional gain kₚ₁ may be established prior to the delta voltage change, and the time it takes for the output voltage vₒ to settle to a new output voltage vₒ of 105V is monitored. A second iteration similar to the first iteration with a second, different value for the proportional gain kₚ₂ may be executed to determine the settling time using the second proportional gain value kₚ₂. The first and second proportional gain values may be compared to determine which value resulted in the shortest settling time. Further, many iterations may be performed with different proportional gain values to identify an optimal proportional gain value for the given input voltage vᵢₙ with a given delta voltage change Δv_{ref} from a given current reference voltage v_{ref}. Thereafter, iterations may again be performed for the given input voltage vᵢₙ starting with the given current reference voltage v_{ref} at different delta voltage changes Δvᵣₑf. In this manner, the optimal proportional gain values k_{p_opt} for a given current reference voltage v_{ref} form a curve of values such as curve v_{ref1}. While keeping the input voltage vᵢₙ constant, additional curves may be similarly determined for other current reference voltages (e.g., v_{ref2}-v_{ref4}) as illustrated.

While four reference voltage curves v_{ref1}-v_{ref4} are illustrated in FIG. 3 for simplicity, other reference voltage curves may also be generated in similar manners as described herein to flesh out additional optimal proportional gain value curves for the given input voltage vᵢₙ. Further, additional curves may be generated in a similar manner for different values of the input voltage vᵢₙ.

The lookup table may be filled with the determined optimal proportional gain values k_{p_opt} such that by using the input voltage vᵢₙ, the current reference voltage v_{ref,old}, and the new voltage reference v_{ref,new}, a delta voltage change Δv_{ref} between the new and old voltage references may be determined and used with the input voltage vᵢₙ and the current reference voltage v_{ref,old} to lookup the determined optimal proportional gain value k_{p_opt}. Alternatively, instead of containing values along the reference voltage curve v_{ref} at distinct delta voltage change values Δvᵣₑf, the lookup table may contain an equation that when evaluated at the delta voltage change value Δv_{ref}, provides the optimal proportional gain value k_{p_opt}.

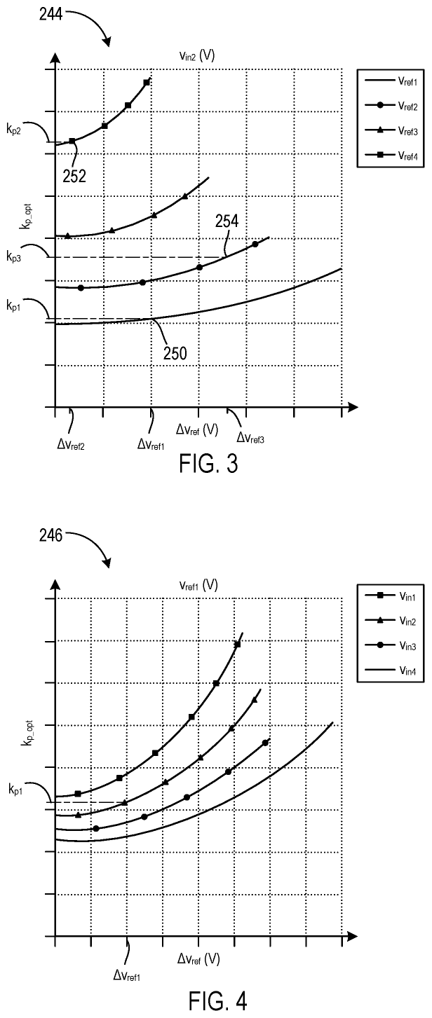

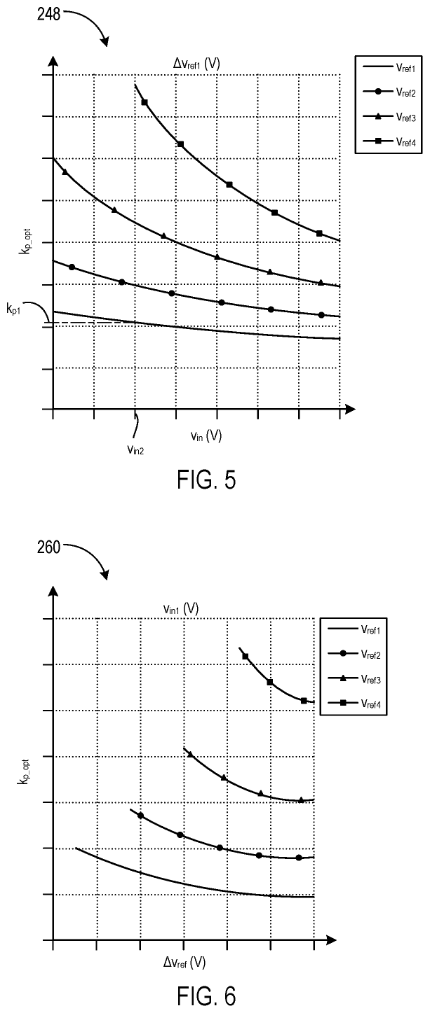

FIG. 4 illustrates plotted optimal proportional gain values k_{p_opt} for different delta voltage change values Δv_{ref} at different input voltages (e.g, vᵢₙ₁-vᵢₙ₂) for a fixed current or beginning reference voltage v_{ref} such as v_{ref1} FIG. 5 illustrates plotted optimal proportional gain values k_{p_opt} for different input voltages vᵢₙ at different current or beginning reference voltages (e.g., v_{ref1}-v_{ref4}) for a fixed delta voltage change value Δv_{ref} such as Δv_{ref1}. The optimal proportional gain values k_{p_opt} may be determined in a similar manner as those of FIG. 3.

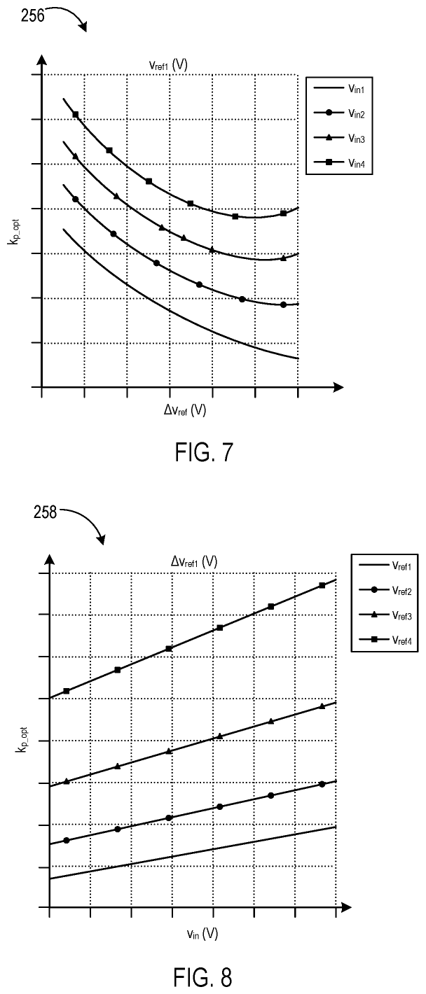

The examples provided in FIGS. 3-5 illustrate curves that can result from a positive delta voltage change or increase (e.g., +Δv_{ref}) from the beginning voltage reference value v_{ref,old} to the new voltage reference v_{ref,new} greater than the beginning voltage reference value. It is noted that a negative delta voltage change or decrease (e.g., −Δv_{ref}) from the beginning voltage reference value v_{ref,old} to the new voltage reference v_{ref,new} less than the beginning voltage reference value may not behave optimally if the direction of the delta voltage change is ignored. That is, the optimal proportional gain value kₚ₁ of FIG. 3 may not be optimal when a negative delta voltage change of −Δv_{ref1} occurs at the given input voltage of vᵢₙ₂ from 105V to 25V in an example. Instead, a plurality of additional curves taking the negative delta voltage changes into account can establish the optimal proportional gain values k_{p_opt} for such situations. For example, FIGS. 6-8 illustrate graphs 256, 258, 260 of plotted optimal proportional gain values k_{p_opt} for each of the respective parameters vᵢₙ, v_{ref}, and Δv_{ref} based on negative delta voltage changes.

A given optimal proportional gain value k_{p_opt} related to a given input voltage vᵢₙ, to a given beginning voltage reference value v_{ref}, and to a given delta voltage change value Δv_{ref} should be substantially identical independent of the manner in which it is determined. That is, whether the input voltage vᵢₙ, the beginning voltage reference value v_{ref}, or the delta voltage change value Δv_{ref} is fixed while varying the other values as described herein, the same respective values for these three variables produce an identical or substantially identical value for the optimal proportional gain value in each method. Therefore, though the axes of FIGS. 3-5 are not illustrated as being normalized with each other, the optimal proportional gain values kₚ₁ in FIGS. 3-5 are identical or substantially identical at the input voltage of vᵢₙ₂, the beginning voltage reference of v_{ref1}, and the delta voltage change value Δv_{ref1}.

Returning to FIG. 2, the gain controller 238 may contain a lookup table 262 within internal memory or may be coupled to external memory containing the lookup table. The lookup table 262 contains values or equations calculated as described above of optimal proportional gain values k_{p_opt} for various combinations of the input voltages vᵢₙ, the beginning voltage reference values v_{ref}, and the delta voltage change values Δvᵣₑf. The gain controller 238 is programmed to look up an optimal proportional gain value k_{p_opt} for the current combination of input voltages vᵢₙ, beginning voltage reference values v_{ref}, and delta voltage change values Δv_{ref} and to update the proportional gain value kₚ in the proportional control 226 with the value returned from the lookup table 262.

In addition to updating the proportional gain value kₚ based on a calculated optimal proportional gain value k_{p_opt} to reduce the settling time of the multilevel converter 200 in response to a step change in the voltage reference v_{ref}, additional benefits in circuit response can be achieved by enabling or disabling the contribution of the integral control 228 to the feedback control voltage 220 calculation. Under large transients, for example, the presence of integral value 232 can affect an optimized operation of the multilevel converter 200. Elimination of the integral value 232 when it is based on a large transient can, therefore, improve circuit operation. Accordingly, the error signal eₜ is provided to a comparator 264 and compared with an error signal threshold eₜₕ. The comparator 264 is coupled to a controllable switch 266. In response to the error signal eₜ being greater than the error signal threshold eₜₕ, the comparator 264 commands the switch 266 into a non-conducting state such that the integral value 232 does not contribute to the feedback control voltage 220. In response to the error signal eₜ being less than the error signal threshold eₜₕ, the comparator 264 commands the switch 266 into a conducting state such that the integral value 232 contributes to the feedback control voltage 220.

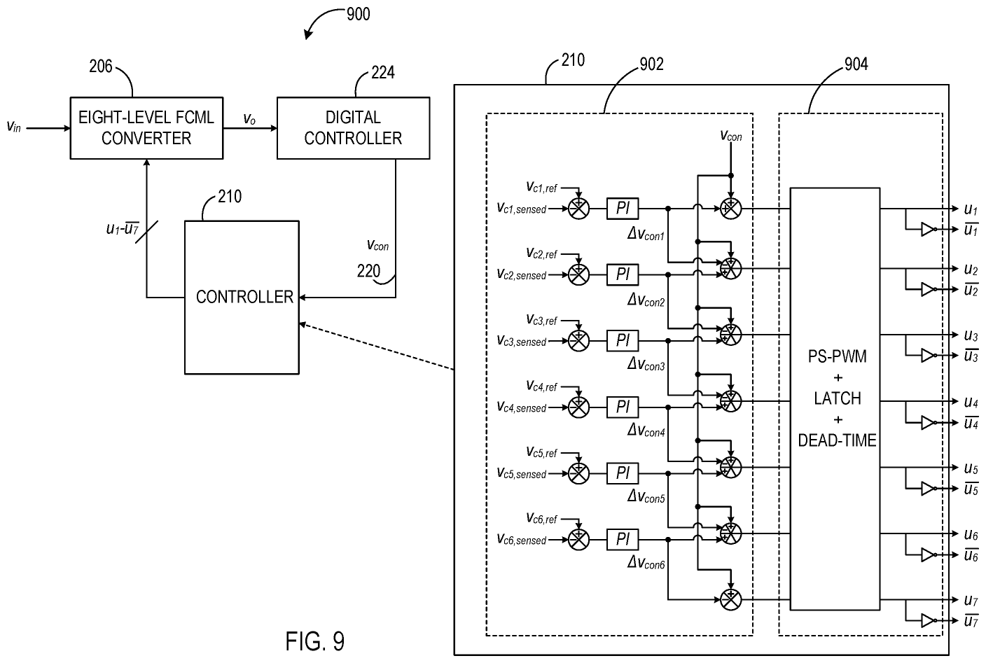

FIG. 9 illustrates a simplified multilevel converter circuit 900 of the multilevel converter 200 of FIG. 2 according to an embodiment. The controller 210 implements a control scheme 902 used to balance the flying capacitor voltages (v_{c1}-v_{c6}) together with a phase-shift modulator 904. The digital controller 224 regulates the output to the desired v_{ref} by setting the control output v_{con} 220. The flying capacitor voltage balancing loops of the control scheme 902 provide slight adjustments in the form of Δv_{con} to the overall control output v_{con} for each pair of half-bridge switch cells. The blocking (OFF state) voltages of the controllable switch devices S₁, S̅₁̅, S₂, S̅₂̅, . . . , S₇, S̅₇̅ are given by:

v_{S}_{₁}=vᵢₙ−v_{C}_{₁} (Eqn. 5);

v_{S}_{₂}=v_{C}_{₁}−v_{C}_{₂} (Eqn. 6);

v_{S}_{₃}=v_{C}_{₂}−v_{C}_{₃} (Eqn. 7);

v_{S}_{₄}=v_{C}_{₃}−v_{C}_{₄} (Eqn. 8);

v_{S}_{₅}=v_{C}_{₄}−v_{C}_{₅} (Eqn. 9);

v_{S}_{₆}=v_{C}_{₅}−v_{C}_{₆} (Eqn. 10);

v_{S}_{₇}=v_{C}_{₆}−v_{sw} (Eqn. 11).

It can be seen from Eqns. 5-11 that the voltage across C₁ can be controlled by small adjustments to the duty cycles of the switch-pairs (S₁, S̅₁̅) and (S₂, S̅₂̅). Similarly, the voltage across C₂ can be regulated by adjusting the duty cycles of the switch-pairs (S₂, S̅₂̅) and (S₃, S̅₃̅) and so on. PI compensators are employed in the flying capacitor balancing loops of the control scheme 902. Thereafter, the phase-shift modulator 904 employs a phase-shift PWM (PS-PWM) scheme followed by latch and dead-time logic circuits to generate the gate signals (u₁, u̅₁̅, u₂, u̅₂̅, . . . , uₙ, u̅ₙ̅) for each individual switch-pair (S₁, S̅₁̅, S₂, S̅₂̅, . . . , S₇, S̅₇̅).

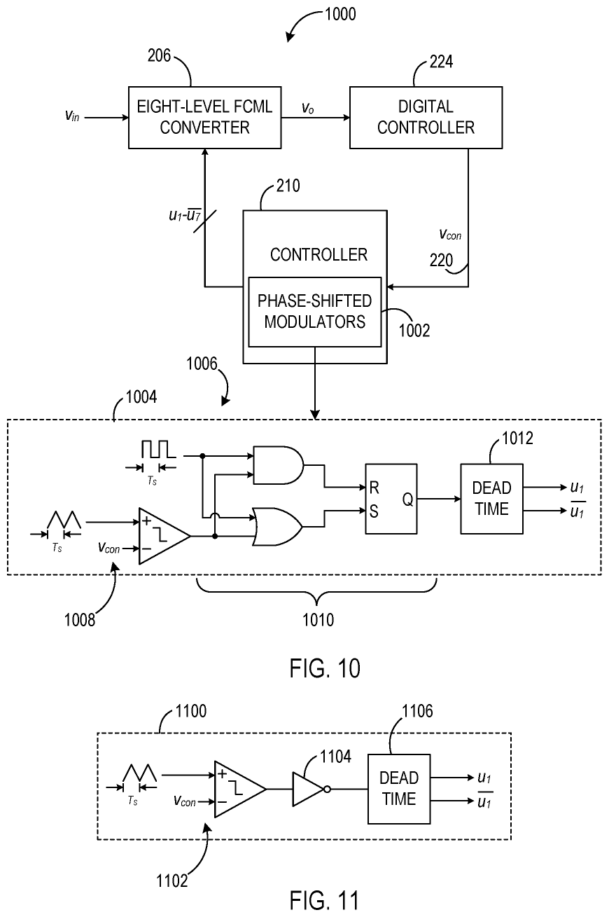

FIG. 10 illustrates a simplified multilevel converter 1000 of the multilevel converter 200 of FIG. 2 according to another embodiment. As shown, controller 210 implements phase-shifted modulators 1002 in one embodiment to generate the gate signals (u₁, u̅₁̅, u₂, u̅₂̅, . . . , u̅ₙ̅, uₙ, for each individual switch-pair (S₁, S̅₁̅, S₂, S̅₂̅, . . . , S₇, S̅₇̅). The modulators 1002 may be implemented as dual edge, leading edge, and/or trailing edge modulators. Referencing a single modulator 1004 as an example, a modulation scheme 1006 including PWM generation via a PWM generator 1008 with latching via a latch circuit 1010 and dead time delay via a dead-time logic circuit 1012 generate the gate signals (u₁, u̅₁̅) for the switch-pair (S₁, S̅₁̅). The PWM generation 1008 may use the feedback control voltage v_{con} 220 as illustrated or may also use the Δv_{con} generated via the control scheme 902 of FIG. 9.

Reduction of the settling time is based in part on reducing the delay introduced by the phase shifted PWM signals along with the inherent modulator delays due to the latching function. Accordingly, in another embodiment, FIG. 11 illustrates a modulator 1100 without a latching function that reduces the number of modulator components as compared with the components of the modulator 1004 of FIG. 10. Modulator 1100 includes PWM generation via a PWM generator 1102, an inverter 1104, and a dead-time logic circuit 1106 to generate the gate signals (u₁, u̅₁̅, u₂, u̅₂̅, . . . , uₙ, u̅ₙ̅). When employed in the controller 210 of the multilevel converters 200, 900, and 1000, an improvement is the settling time can be realized together with the other settling time reduction schemes disclosed herein.

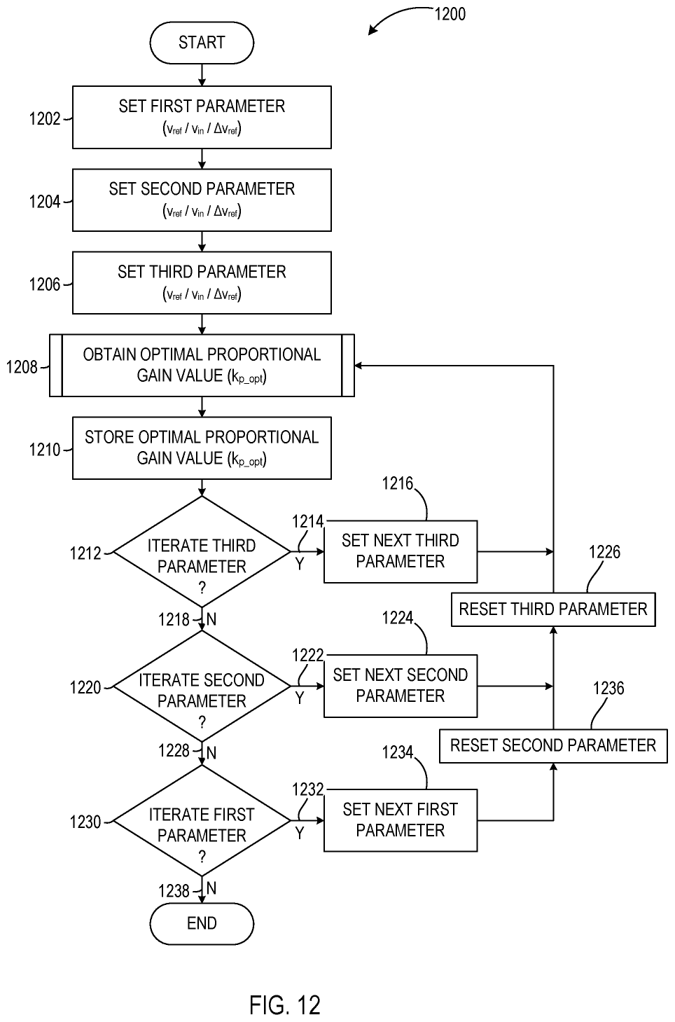

FIG. 12 illustrates a flowchart illustrating a lookup table generation procedure 1200 according to an embodiment. The procedure 1200 forms a method for storing the optimal proportional gain values (e.g., such as in one or more lookup tables) illustrated in the graph 244, 246, 248 of FIGS. 3-5, for example. First, second, and third parameters are set in blocks 1202, 1204, 1206. The parameters correspond to voltage reference v_{ref}, delta voltage change Δv_{ref}, and input voltage yᵢₙ parameters. Referring FIGS. 3-5, in one embodiment, the third parameter corresponds with the parameter varying along the horizontal axis (e.g., the delta voltage change Δv_{ref} of FIGS. 3 and 4, or the input voltage yᵢₙ of FIG. 5), the second parameter corresponds with the parameter varying by curve (e.g., the reference voltage v_{ref} of FIGS. 3 and 5, or input voltage yᵢₙ of FIG. 4), and the first parameter corresponding with the fixed parameter of each figure (e.g., the input voltage vᵢₙ of FIG. 3, the reference voltage v_{ref} of FIG. 4, or the delta voltage change Δv_{ref} of FIG. 5). The first parameters are fixed or unvarying as they relate to the corresponding graphs illustrated in FIGS. 3-5, but they are not unchangeable. For example, the optimal proportional gain values k_{p_opt} of curves v_{ref1}-v_{ref4} of FIG. 3 correspond to the relationships between varying delta voltage change Δv_{ref} and varying reference voltages v_{ref1}-v_{ref4} for a given input voltage. By changing the input voltage to a different value, additional relationships between varying delta voltage change v_{ref} and varying reference voltages v_{ref1}-v_{ref4} for the different input voltage can be determined.

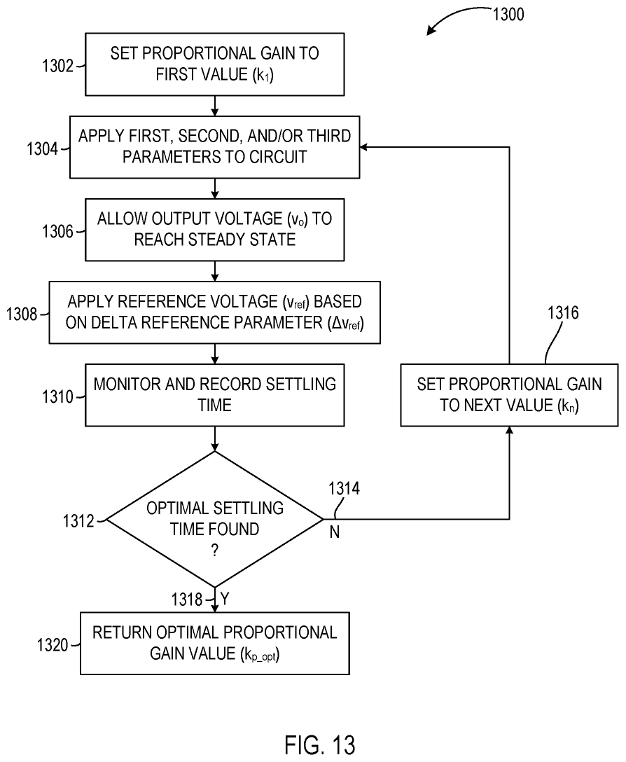

At block 1208, an optimal proportional gain value k_{p_opt} for a circuit such as multilevel converter 200 of FIG. 2 based on the first, second, and third parameters is determined by a proportional gain calculation procedure 1300 illustrated in FIG. 13. Referring to FIG. 13, the proportional gain value in the proportional control (e.g., the proportional control 226 of FIG. 2) is set to a first value at block 1302. The parameters of the first, second, and third parameters related to the input voltage vᵢₙ and a base voltage reference v_{ref} of the circuit are applied at block 1304, and the output voltage vₒ is allowed to reach a steady state at block 1306.

After the steady state has been reached, the response of the circuit to a different reference voltage v_{ref} can be observed. Accordingly, a new reference voltage v_{ref} is applied to the circuit at block 1308 based on the delta voltage change Δv_{ref} corresponding with the first, second, or third parameter. The circuit's settling time response to the reference voltage change is monitored and recorded at block 1310. The settling time corresponds with the time it takes for the output voltage vₒ to settle to or around the new reference voltage v_{ref} after the reference voltage change. The active proportional gain value kₚ corresponding with the settling time is recorded with the settling time. The recorded settling time is evaluated to determine if it corresponds with an optimal settling time at block 1312. In one embodiment, a most-recent recorded settling time may be compared with previously-recorded settling times to determine which settling time is the shortest. In another embodiment, the recorded settling time may be compared with a target threshold. If an optimal settling time has not been found 1314, a next proportional gain value kₙ is set at block 1316, the procedure 1300 returns to block 1304 for another iteration of blocks 1304-1312 with the next proportional gain value kₙ set in the proportional control. If an optimal settling time has been found 1318, the procedure 1300 returns (at block 1320) the proportional gain value kₙ associated with the optimal settling time to the procedure 1200 as an optimal proportional gain value k_{n_opt} for the first, second, and third parameter combination.

Returning to FIG. 12, the procedure 1200 stores the returned optimal proportional gain value k_{n_opt} at block 1210 in a lookup table corresponding to the first, second, and third parameters. At block 1212, the procedure 1200 determines whether to iterate the third parameter. The third parameter may be iterated when filling out optimal proportional gain values based on a given second parameter such as, for example, when obtaining a range of optimal proportional gain values for the v_{ref4} curve at the input voltage vᵢₙ₂ of FIG. 3. If the third parameter is to be iterated 1214, a next value for the third parameter is determined or set (at block 1216) such as by incrementing or decrementing the third parameter by a given value to yield the next third parameter. Thereafter, the procedure 1200 returns to block 1208 to obtain a new optimal proportional gain value based on the new combination of first, second, and third parameters.

If iteration of the third parameter is completed or otherwise not to be incremented 1218, the procedure 1200 determines whether to iterate the second parameter at block 1220. The second parameter may be iterated when filling out a range for optimal proportional gain values for another second parameter at the first parameter such as, for example, when obtaining a range of optimal proportional gain values for the v_{ref3} curve of FIG. 3 after filling out the values for the v_{ref4} curve. If the second parameter is to be iterated 1222, a next value for the second parameter is determined or set (at block 1224) such as by incrementing or decrementing the second parameter by a given value to yield the next second parameter. The third parameter may then be reset at block 1226 to be iterated over its range for the new second parameter. The procedure 1200 returns to block 1208 to obtain a new optimal proportional gain value based on the new combination of first, second, and third parameters.

If iteration of the second parameter is completed or otherwise not to be incremented 1228, the procedure 1200 determines whether to iterate the first parameter at block 1230. The first parameter may be iterated when filling out a range optimal proportional gain values for one or more second parameters at a new first parameter such as, for example, when obtaining a range of optimal proportional gain values for curves v_{ref1}-v_{ref4} of FIG. 3 for the new first parameter. If the second parameter is to be iterated 1232, a next value for the first parameter is determined or set (at block 1234) such as by incrementing or decrementing the first parameter by a given value to yield the next first parameter. The second parameter may then be reset at block 1236 to be iterated over its range for the new first parameter. The procedure 1200 proceeds to block 1226 to also reset the third parameter for iteration over its range. The procedure 1200 returns to block 1208 to obtain a new optimal proportional gain value based on the new combination of first, second, and third parameters. If iteration of the first parameter is completed or otherwise not to be incremented 1238, the procedure 1200 ends.

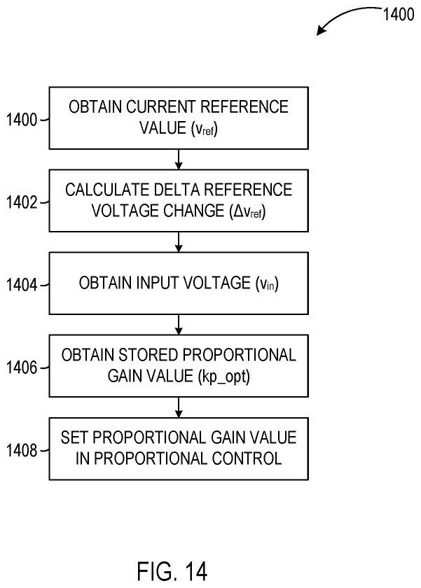

The lookup table(s) generated through procedures 1200, 1300 of FIGS. 12 and 13 may be used by the gain controller 238 during operation of the multilevel converter 200 of FIG. 2. FIG. 14 illustrates a flowchart illustrating a proportional gain value modification procedure 1400 usable by the gain controller 238 according to an embodiment. At block 1402, the gain controller 238 obtains a current reference value v_{ref} representing the target output voltage desired for the multilevel converter 200. a delta reference voltage change Δv_{ref} is calculated at block 1404 between the current reference value v_{ref} and the previous reference value v_{ref,old} stored in the gain controller 238. The input voltage vᵢₙ is also obtained at block 1406 and may correspond with a sensed measurement of the input voltage vᵢₙ or with a value obtained from another controller. Based on the input voltage vᵢₙ, the calculated delta reference voltage change Δv_{ref}, and the initial reference voltage v_{ref,old} before the change to the new voltage reference v_{ref,new}, the optimal proportional gain value k_{p_opt} for the combination of vᵢₙ, Δv_{ref}, and v_{ref,old} is obtained at block 1408 by searching one or more lookup tables corresponding with the values for the vᵢₙ, Δv_{ref}, and v_{ref,old}. If a previously-stored optimal proportion gain value for the current combination of vᵢₙ, Δv_{ref}, and v_{ref,old} values is not found in any lookup table, the gain controller 238 may interpolate the optimal proportional gain value k_{p_opt} based on one or more of the stored vᵢₙ, Δv_{ref}, and v_{ref,old} values surrounding the active stored vᵢₙ, Δv_{ref}, and v_{ref,old} values. The obtained optimal proportional gain value k_{p_opt} is then used to set the gain value in the proportional control 226.

Embodiments of the disclosure provide for the determination of optimal proportional gain values k_{p_opt} that correspond with circuit parameters determined to be affected thereby. One or more lookup tables can be generated and further evaluated during circuit operation to return the optimal proportional gain value k_{p_opt} for the active circuit parameters. In this manner, near time optimal response in the output voltage vₒ is achievable in response to changing from an initial value substantially equal to a v_{ref,old} value to a subsequent value substantially equal to a v_{ref,new} value.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

1. A voltage converter comprising:
a voltage input adapted to receive an input DC voltage;
a DC-to-DC converter comprising a plurality of controllable switch devices and configured to convert the input DC voltage into an output DC voltage;
a voltage output adapted to receive the output DC voltage;
a drive control circuit configured to generate switch control signals a feedback circuit coupled to the DC-to-DC converter and comprising:
a proportional control; and
a gain controller;
wherein the feedback circuit is configured to:
receive a sensed output voltage based on the output DC voltage;
receive a voltage reference;
obtain an input voltage value based on the input DC voltage;
generate an error signal based on a comparison of the sensed output voltage with the voltage reference;
obtain a proportional gain value based on the voltage reference and the input voltage value;
generate a proportional value based on the proportional gain value and the error signal; and
wherein the drive control circuit is further configured to generate the switch control signals based on the generated proportional value.

2. The voltage converter of claim 1, wherein the DC-to-DC converter comprises:
a multi-stage assembly comprising:
a plurality of stages, each stage comprising a respective pair of the plurality of controllable switch devices; and
a plurality of capacitors, each capacitor positioned between a respective pair of the plurality of stages;
an inductor serially coupled between the multi-stage assembly and the voltage output; and
a capacitor coupled to the inductor and coupled in parallel with the voltage output.

3. The voltage converter of claim 2, wherein the drive control circuit comprises a plurality of modulation circuits, each modulation circuit configured to generate a pair of switch control signals for a respective stage of the plurality of stages.

4. The voltage converter of claim 3, wherein each modulation circuit comprises:
a pulse-width modulation (PWM) generator; and
a dead-time logic circuit.

5. The voltage converter of claim 4, wherein each modulation circuit further comprises a latch circuit.

6. The voltage converter of claim 1, wherein the received voltage reference comprises a current voltage reference; and
wherein the gain controller is configured to:
receive the current voltage reference;
receive the input voltage value;
generate a delta voltage change based on a difference between a previously-received voltage reference and the current voltage reference;
obtain the proportional gain value based on the previously-received voltage reference, the input voltage value, and the delta reference change.

7. The voltage converter of claim 6, wherein the gain controller is further configured to obtain the proportional gain value based on a lookup table comprising a plurality of the proportional gain values, each proportional gain value corresponding with a respective combination of a voltage reference, an input voltage, and a delta reference change.

8. The voltage converter of claim 6, wherein the proportional gain value comprises a value configured to cause the voltage converter to change the output DC voltage from a first value substantially equal to a value of the previously-received voltage reference to a second value substantially equal to a value of the current voltage reference in a near time optimal settling time.

9. The voltage converter of claim 1 further comprising an integral control configured to generate an integral value based on an integral gain value and the error signal.

10. The voltage converter of claim 9 further comprising a comparator configured to:
compare the error signal with an error threshold signal; and
control, based on the comparison, a conduction of a switch into a conducting state if the error signal is less than the error threshold signal and into a non-conducting state if the error signal is greater than the error threshold signal;
wherein, when the switch is in the conducting state, the drive control circuit is further configured to generate the switch control signals further based on the integral value; and
wherein, when the switch is in the non-conducting state, the drive control circuit is further configured to generate the switch control signals absent a contribution of the integral value.

11. A method for controlling a DC-DC converter, wherein the DC-DC converter comprises:
a DC-to-DC converter;
a drive control circuit; and
a feedback circuit;
wherein the method comprises:
providing, to the feedback circuit, a sensed output voltage, an input voltage value, and a voltage reference;
generating an error signal based on the sensed output voltage and the voltage reference;
obtaining a proportional gain value based on the voltage reference and the input voltage value;
generating a proportional value based on the error signal and the proportional gain value; and
driving the DC-to-DC converter to generate an output voltage based on the proportional value.

12. The method of claim 11, wherein obtaining the proportional gain value comprises:
accessing a lookup table;
identifying a respective proportional value associated with the voltage reference, the input voltage value, and a delta reference change based on the voltage reference.

13. The method of claim 12 further comprising generating the delta reference change based on a difference between the voltage reference and a previously-received voltage reference.

14. The method of claim 13, wherein the delta reference change comprises a positive delta reference change if the previously-received voltage reference is less than the voltage reference; and
wherein the delta reference change comprises a negative delta reference change if the previously-received voltage reference is greater than the voltage reference.

15. The method of claim 11 further comprising:
generating an integral value based on the error signal and an integral gain value;
driving the DC-to-DC converter to generate the output voltage based on input from the integral gain value if the error signal is lower than an error threshold signal; and
driving the DC-to-DC converter to generate the output voltage absent input from the integral gain value if the error signal is greater than the error threshold signal.

16. A method for generating a proportional gain value lookup table for a DC-DC converter circuit, wherein the DC-DC converter circuit comprises:
a DC-to-DC converter;
a drive control circuit; and
a feedback circuit comprising a proportional control;
wherein the method comprises:
setting a proportional gain value of the proportional control to a first proportional gain value;
executing an iteration sequence comprising:
setting a first circuit parameter for the DC-DC converter circuit;
setting a second circuit parameter for the DC-DC converter circuit;
setting a third circuit parameter for the DC-DC converter circuit;
controlling the DC-DC converter circuit based on ones of the first, second, and third circuit parameters related to an input voltage and a beginning reference voltage and based on the proportional gain value;
applying a new reference voltage to the DC-DC converter circuit, wherein the new reference voltage is based on one of the first, second, and third circuit parameters related to a delta reference voltage change;
controlling the DC-DC converter circuit based on application of the new reference voltage and based on the proportional gain value;
monitoring an output voltage of the DC-DC converter circuit to determine a settling time of the output voltage in reaching a value substantially equal to a value of the new reference voltage; and
storing the proportional gain value if the settling time is below a target threshold.

17. The method of claim 16 further comprising iterating execution of the iteration sequence based on distinct values of the proportional gain value if the settling time is above the target threshold for each of the distinct values.

18. The method of claim 17 further comprising:
recording a plurality of settling times, each settling time corresponding to a respective iteration sequence execution; and
wherein storing the proportional gain value comprises storing the proportional gain value associated with the shortest settling time of the plurality of settling times.

19. The method of claim 16 further comprising iterating execution of the iteration sequence based on distinct values of the third circuit parameter for each of a plurality of second circuit parameters.

20. The method of claim 19 further comprising iterating execution of the iteration sequence based on distinct values of the second circuit parameter for each of a plurality of first circuit parameters.
